(19) United States
(12) Patent Application Publication
(10) Pub. No.: US 2023/0363408 A1
(43) Pub. Date: Nov. 16, 2023

(54) PLANT BASED SOFT SERVE FROZEN DESSERT COMPOSITION

(71) Applicant: SOCIETE DES PRODUITS NESTLE S.A., Vevey (CH)

(72) Inventors: TIMOTHY JAMES WOOSTER, Orbe (CH); MARINA BORTOLIN, Gollion (CH); PIERRE-ALAIN RICHON, Villeneuve (FR) (CH); BEAT GERBER, Moudon (CH); JULIEN HUGO, Orny VD (CH)

(21) Appl. No.: 18/044,658

(22) PCT Filed: Sep. 10, 2021
(86) PCT No.: PCT/EP2021/074969

§ 371 Date: Mar. 9, 2023

(30) Foreign Application Priority Data
Sep. 10, 2020 (EP) 20195593.7

(51) Int. Cl. A23G 9/42; A23G 9/32; A23G 9/34; A23G 9/04; A23J 3/14

(52) U.S. Cl. CPC A23G 9/42; A23G 9/327; A23G 9/34; A23G 9/04; A23J 3/14

(57) ABSTRACT

The invention relates to a plant based liquid or a frozen dessert, said plant based liquid or frozen dessert comprising (i) a dry fractionated plant protein, (ii) sugar or a polyol; (iii) optionally one or more hydrocolloid(s); (iv) one or more emulsifiers; (v) a fat phase, wherein said fat phase solidifies at a temperature less than 30° C., and wherein said fat phase comprises one or more fat sources.

### FIELD OF INVENTION

The present invention relates to plant based soft serve frozen dessert compositions and to the process for producing said compositions.

### BACKGROUND OF THE INVENTION

Recent years have seen a huge growth in demand for plant based (non-dairy) alternative products. Plant based dairy alternatives are largely manufactured using either whole ingredients or protein isolates which require large amounts of water and chemicals to purify the protein from the raw plant flour.

US20200178556A1 describes the creation of a plant based frozen confection using whole Navy Beans as a source of plant protein. The problem with using whole Navy beans in the preparation of a frozen confection is that it brings high viscosity, and it is difficult to achieve sufficient freezing point depression. Inadequate freezing point depression leads to an unappealing gritty sandy ice cream texture due to the formation of large ice crystals.

In order to avoid this negative effect of plant products made from whole beans, the food industry typically uses purified plant proteins such as protein isolates. The problem with protein isolates is that they consume large amounts of water and energy in their manufacture, and the resulting proteins are aggregated and have poor solubility.

Plant based dairy alternatives are also well known to have a brown or grey colour which negatively affects consumer appeal due to a lack of similarity to milk whiteness.

There is a clear need to develop new process and recipe solutions that deliver tasty, nutritious & affordable plant based dairy alternatives with an appealing colour.

### SUMMARY OF THE INVENTION

The inventors have developed a method which solves the abovementioned problems and leads to a superior plant based frozen dessert.

In a first aspect, the invention relates to a method of making a plant based liquid or frozen dessert, said method comprising dispersing oil in a plant protein mixture; forming an emulsion; applying a thermal treatment to the emulsion to form a plant based liquid; and optionally freezing the plant based liquid to form a frozen dessert.

In a second aspect, the invention relates to a plant based liquid or frozen dessert made by a method as described herein.

### BRIEF DESCRIPTION OF THE FIGURES

FIG. 1: A) Particle size distribution and B) confocal laser scanning microscopy images of example one plant protein liquid without small molecule emulsifier.

FIG. 2: A) Particle size distribution and B) and C) confocal laser scanning microscopy images of example two plant protein liquid with small molecule emulsifier. Confocal image B) using Fast Green and Nile Red (fat emulsion) staining and image C) image highlighting only the nile red staining of the fat droplets.

FIG. 3: A) Particle size distribution and B) confocal laser scanning microscopy images of example one soft serve ice cream liquid without small molecule emulsifier.

FIG. 4: Confocal laser scanning microscopy images of microstructure of soft serve ice cream manufactured from example two plant protein liquid with small molecule emulsifier. Confocal image A) using Fast Green and Nile Red (fat emulsion) staining and image B) image highlighting only the nile red staining of the fat droplets.

FIG. 5: Visual appearance of difference plant based liquids after repeated pasteurisation in soft serve ice cream machine. Sample compositions: A) Example 3 without sodium ascorbate, B) example 4A, C) example 4B and D) example 4C.

FIG. 6: Visual appearance (A) and Lightness (B) of plant based liquid and resulting (melted) soft serve ice cream after aeration.

### EMBODIMENTS OF THE INVENTION

### Method of Making a Plant Based Liquid or a Frozen Dessert

The invention relates in general to a method of making a plant based liquid or a frozen dessert, said method comprising dispersing oil in a plant protein mixture; forming an emulsion; applying a thermal treatment to the emulsion to form a plant based liquid; and optionally freezing the plant based liquid to form a frozen dessert.

In particular, the invention relates to a method of making a plant based liquid or a frozen dessert, said method comprising dispersing oil in a plant protein mixture, wherein the plant protein mixture is formed by dissolving a dry fractionated plant protein in water; adding a sugar or polyol to the plant protein mixture; adding one or more emulsifiers to the plant protein mixture; dispersing a fat phase in the plant protein mixture; forming an emulsion; applying a thermal treatment to the emulsion to form a plant based liquid; and optionally freezing the plant based liquid to form a frozen dessert.

In particular, the invention relates to a method of making a plant based liquid or a frozen dessert, said method comprising
a. Dissolving a fractionated plant protein in water to form a plant protein mixture having a pH of between 6 and 9, preferably 6.7 and 8;
b. Adding sugar or a polyol to the plant protein mixture;
c. Optionally adding one or more hydrocolloid to the plant protein mixture;
d. Adding one or more emulsifiers to the plant protein mixture;
e. Dispersing a fat phase in the plant protein mixture, wherein said fat phase solidifies at a temperature of less than 30° C. and wherein said fat phase comprises one or more fat sources;
f. Homogenizing the plant protein mixture to form an emulsion;
g. Applying a thermal treatment to the emulsion to form a plant based liquid;
h. Optionally freezing the plant based liquid to form a frozen dessert.

In some embodiments, between 2.5 to 10 wt % of dry fractionated plant protein is dissolved to form a plant protein mixture. Preferably, between 4 to 8 wt % of dry fractionated plant protein is dissolved to form a plant protein mixture. Preferably, between 4.5 to 7.7 wt % of dry fractionated plant protein is dissolved to form a plant protein mixture.

In particular, the invention relates to a method of making a plant based liquid or a frozen dessert, said method comprising
a. Dissolving a dry fractionated plant protein in water to form a plant protein mixture having a pH of between 6 and 9, preferably 6.7 and 8;
b. Adding sugar or a polyol to the plant protein mixture;
c. Optionally adding one or more hydrocolloid to the plant protein mixture;
d. Adding one or more emulsifiers to the plant protein mixture;
e. Dispersing a fat phase in the plant protein mixture, wherein said fat phase solidifies at a temperature of less than 30° C. and wherein said fat phase comprises one or more fat sources;
f. Homogenizing the plant protein mixture to form an emulsion;
g. Applying a thermal treatment to the emulsion to form a plant based liquid;
h. Optionally freezing the plant based liquid to form a frozen dessert.

In some embodiments, between 2.5 to 10 wt % of dry fractionated plant protein is dissolved to form a plant protein mixture. Preferably, between 4 to 8 wt % of dry fractionated plant protein is dissolved to form a plant protein mixture. Preferably, between 4.5 to 7.7 wt % of dry fractionated plant protein is dissolved to form a plant protein mixture.

In some embodiments, the dry fractionated plant protein is derived from a legume source, for example faba bean, pea, chickpea or lentil, preferably faba bean.

In some embodiments, the dry fractionated plant protein is made using air classification.

In some embodiments, the dry fractionated plant protein has a starch fraction of less than 14 wt % on a dry basis, preferably between 5 to 14 wt % on a dry basis.

In some embodiments, the dry fractionated plant protein has a protein content of at least 50 wt % on a dry basis, or at least 60 wt % on a dry basis, or between 50 to 80 wt % on a dry basis, or between 50 to 70 wt % on a dry basis.

In some embodiments, the dry fractionated plant protein is a protein concentrate or protein powder, preferably a protein concentrate.

In some embodiments, sodium ascorbate is dissolved in the plant protein mixture or the emulsion. In some embodiments, a sodium ascorbate alternative is used.

In some embodiments, the sugar is sucrose or glucose syrup, or a mixture thereof. Preferably, up to 20 wt % sugar is added in step d). Preferably, 10 to 20 wt % sugar is added in step d). Preferably, 12 to 16 wt % sucrose is added in step d).

In some embodiments, the polyol is sorbitol or glycerol. Preferably, the polyol has a molecular weight of less than 400 g per mole.

In some embodiments, the hydrocolloid is carrageenan or cellulose gum, preferably carrageenan.

In some embodiments, the emulsifier is a secondary small molecule emulsifier, for example a monoglyceride, a lecithin, or a synthetic surfactant, such as lactem

In some embodiments, the fat phase solidifies at a temperature less than 20° C. In some embodiments, the fat phase solidifies at a temperature less than 10° C.

In some embodiments, the fat source is coconut or cocoa butter.

In some embodiments, the thermal treatment of the emulsion occurs before and/or during step f).

In some embodiments, the plant based liquid or frozen dessert is devoid of animal products.

In some embodiments, the frozen dessert is a soft serve ice cream, for example a faba based soft serve ice cream.

### Plant Based Liquid or Frozen Dessert

The invention also relates to a plant based liquid or a frozen dessert made by a method as described herein.

The invention also relates to a plant based liquid or a frozen dessert, said plant based liquid or frozen dessert comprising (i) a dry fractionated plant protein; (ii) sugar or a polyol; (iii) optionally one or more hydrocolloid(s); (iv) one or more emulsifiers; (v) a fat phase, wherein said fat phase solidifies at a temperature less than 30° C., and wherein said fat phase comprises one or more fat sources.

In some embodiments, the plant based liquid or frozen dessert comprises between 2.5 to 10 wt % of dry fractionated plant protein, preferably, between 4 to 8 wt % of dry fractionated plant protein, preferably between 4.5 to 7.7 wt % of dry fractionated plant protein.

In some embodiments, the dry fractionated plant protein is derived from a legume source, for example faba bean, pea, chickpea or lentil, preferably faba bean.

In some embodiments, the dry fractionated plant protein is made using air classification.

In some embodiments, the dry fractionated plant protein has a starch fraction of less than 14 wt % on a dry basis, preferably between 5 to 14 wt % on a dry basis.

In some embodiments, the dry fractionated plant protein has a protein content of at least 50 wt % on a dry basis.

In some embodiments, the dry fractionated plant protein is a protein concentrate or protein powder, preferably a protein concentrate.

In some embodiments, the plant based liquid or frozen dessert comprises sodium ascorbate.

In some embodiments, the sugar is sucrose or glucose syrup, or a mixture thereof. Preferably, the plant based liquid comprises up to 20 wt % sugar, or 10 to 20 wt % sugar.

In some embodiments, the polyol is sorbitol or glycerol. Preferably, the polyol has a molecular weight of less than 400 g per mole.

In some embodiments, the hydrocolloid is carrageenan or cellulose gum, preferably carrageenan.

In some embodiments, the emulsifier is a secondary small molecule emulsifier, for example a monoglyceride, a lecithin, or a synthetic surfactant, such as lactem.

In some embodiments, the fat source is coconut or cocoa butter.

In some embodiments, the plant based liquid or frozen dessert is devoid of animal products.

In some embodiments, the frozen dessert is a soft serve ice cream.

In some embodiments, the frozen dessert comprises greater than 0.5 wt % fat

In some embodiments, the frozen dessert comprises between 0.5 to 25 wt % fat, wherein the fat is emulsified in a plant based liquid.

In some embodiments, the frozen dessert comprises between 5 to 6 wt % fat.

In some embodiments, the frozen dessert comprises 10 to 20 wt % sucrose, or between 12 to 16 wt % sucrose.

In some embodiments, the frozen dessert comprises between 10 to 20, preferably 14 to 19 wt % sucrose and glucose syrup in combination.

In some embodiments, the frozen dessert comprises between 5 to 6 wt % fat and between 12 to 16 wt % sucrose. This is typical for a soft serve type dessert.

In some embodiments, the frozen dessert is devoid of animal products.

The invention also relates to use of a plant based liquid as described herein in the manufacture of a frozen dessert.

In some embodiments, the frozen dessert is manufactured in a soft serve ice cream machine to form a soft serve ice cream.

In some embodiments, the frozen dessert is packaged and stored at a temperature of less than 4° C.

In some embodiments, the frozen dessert is a vegan soft serve ice cream, preferably a faba based soft serve ice cream.

### DETAILED DESCRIPTION OF THE INVENTION

When a composition is described herein in terms of wt %, this means wt % of the total recipe, unless indicated otherwise.

As used herein, “about” is understood to refer to numbers in a range of numerals, for example the range of −30% to +30% of the referenced number, or −20% to +20% of the referenced number, or −10% to +10% of the referenced number, or −5% to +5% of the referenced number, or −1% to +1% of the referenced number. All numerical ranges herein should be understood to include all integers, whole or fractions, within the range. Moreover, these numerical ranges should be construed as providing support for a claim directed to any number or subset of numbers in that range. For example, a disclosure of from 45 to 55 should be construed as supporting a range of from 46 to 54, from 48 to 52, from 49 to 51, from 49.5 to 50.5, and so forth.

The term “vegan” refers to an edible composition which is entirely devoid of animal products, or animal derived products.

Dry fractionated plant proteins may be derived from faba, pea, chickpea, lentil, cowpea, pinto bean, mung bean, adzuki bean, common bean, kidney beans, navy beans or similar high carbohydrate (>30 wt %) low fat (<15%) crops or the like.

Fat sources may include vegetable oils, animal fats, milk fats, fish oil, algal oil, sunflower oil, olive oil, canola oil, cotton seed oil, palm fat, palm stearin, palm kernel oil, corn oil, coconut oil, and/or high oleic acid sunflower oil, any solid fat stock such as refined coconut oil, anhydrous milk fat, hydrogenated vegetable oil, tallow, lard, any nut butter/oil such as almond butter, peanut butter, walnut butter, cashew butter and/or hydrogenated or partially hydrogenated fats. Preferably, the fat source is a plant based fat source, for example vegetable oils, algal oil, sunflower oil, olive oil, canola oil, cotton seed oil, palm fat, palm stearin, palm kernel oil, corn oil, coconut oil, and/or high oleic acid sunflower oil, any solid fat stock such as refined coconut oil, anhydrous milk fat, hydrogenated vegetable oil, any nut butter/oil such as almond butter, peanut butter, walnut butter, cashew butter and/or hydrogenated or partially hydrogenated fats.

Sodium ascorbate alternatives include vitamin C, calcium ascorbate, vitamin C palmitate, fruit juices rich in vitamin C (≥500 mg vitamin C per 100 mL), acerola extract, sodium bisulfite, iodine, potassium iodide, sorbic acid, potassium sorbate, sulfite derivatives such as sodium sulfite, sodium hydrogen sulfite, sodium metabisulfite, potassium metabisulfite, calcium sulfite, calcium hydrogen sulfite.

Buffer alternatives to Dipotassium phosphate include trisodium citrate, tripotassium citrate, tripotassium phosphate, sodium bicarbonate, baking soda, bicarbonate of soda, disodium phosphate, trisodium phosphate, monopotassium phosphate, citric acid, lemon juice.

Calcium sources include tricalcium phosphate, calcium carbonate, calcium glycerolphosphate, calcium citrate.

Sucrose alternatives include cane sugar, beat sugar, glucose syrup, maltodextrin, honey and other natural sugar syrups such as agave. Preferably, the sucrose alternative is glucose syrup.

A hydrocolloid means a stabiliser based on (high or low acetyl) gellan, guar gum, (high or low methoxy) pectin, locust bean gum, alginate, carrageenan, carboxymethylcellulose, microcrystalline cellulose, curdlan, xanthan gum or the like may be used.

The plant protein mixture is emulsified. In some embodiments, the emulsion is formed using a two-stage high pressure homogenizer. In some embodiments, the emulsion average particle size is between 0.3 and 8 μm for d[3,2] and 0.5 and 20 μm for d[4,3], preferably the emulsion average particle size is between 0.5 and 3 μm for d[3,2] and 1 and 8 μm for d[4,3].

Pasteurization heat treatment can be within a range from 60° C.-100° C. for 1 second to 300 seconds.

Thermal treatment, for example direct and indirect UHT heat treatment can be within a range of 110° C. to 150° C. for 3 seconds to 60 seconds, preferably the thermal heat treatment is indirect heat treatment.

Retort heat treatment the thermal process delivered to this product shall be designed to deliver a lethality (Fo) in the range 5.0-15 minutes (or higher) but in no case shall be lower than 3.0 minutes. Upon establishing the come-up time (CUT) to reach the pre-determined minimum temperature in the retort, a time and temperature range that may satisfy the lethality range is 7-25 minutes at 119-125 deg C. in the sterilization step. The CUT and sterilization time are to be established by a competent thermal process authority.

The dry fractionated plant protein typically contains up to 20 wt % starch, preferably between 2 and 15 wt % and up to 20 wt % fibre, preferably between 6 to 18 wt % on a dry weight basis.

A legume is a plant in the family Fabaceae (or Leguminosae), the seed of such a plant (also called pulse). Legumes are grown agriculturally, primarily for human consumption, for livestock forage and silage, and as soil-enhancing green manure. As used herein, the term “legume” may include: faba bean, pea, chickpea, lentils, kidney beans, navy beans, pinto beans, haricot beans, lima beans, butter beans, azuki beans, mung beans, golden gram, green gram, black gram, urad, scarlet runner beans, rice beans, garbanzo beans, cranberry beans, lima beans, green peas, snow peas, snap peas, split peas and black-eyed peas. Preferably, the legume is selected from faba bean, pea, chickpea, and lentils.

Vicia faba, also known in the culinary sense as the broad bean, fava bean, or faba bean, or faba, is a species of flowering plant in the pea and bean family Fabaceae.

By way of example and not limitation, the following examples are illustrative of various embodiments of the present invention.

### EXAMPLE 1

### Production of Faba Based Soft Serve Pre-Mix—No Secondary Emulsifier

Ingredion FABA Concentrate-Vitessence Pulse 3600 was used as a faba bean source. According to the manufacturer, it is 100% faba bean protein powder, derived from the dehulled split faba (or fava) bean cotyledons of faba (or fava) beans (Vicia faba)). It has maximum moisture content of 9%, minimum protein content of 60% (dry basis), minimum starch content of 4% (dry basis), and a maximum fat content of 4% (dry basis).

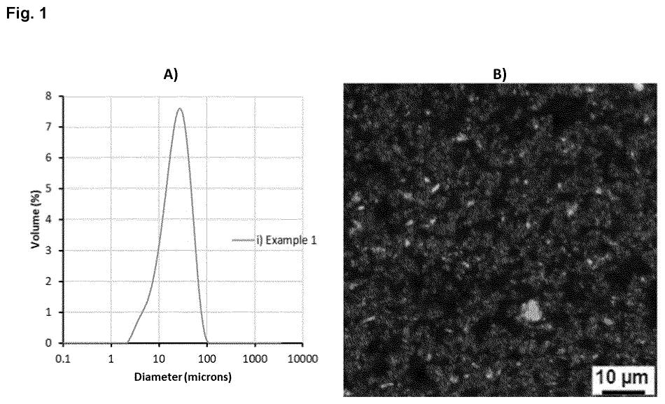

3.9 kg of Faba concentrate was dissolved in 35.8 kg of water at 65° C. with stirring, to this was added 7 kg of sucrose, 80 grams of dipotassium phosphate, and 35 grams of sodium ascorbate. This mixture was mixed at 65° C. for 15 minutes to ensure complete dissolution. The pH of the mixture was then adjusted to 7.5 with 1M NaOH. 2.5 kg of refined coconut fat (mp 22-24° C.) was heated to <60° C. and mixed until a homogeneous liquid was achieved. The fat/monoglyceride blend was then added to the mix then final volume made to 50 litres and the oil was coarsely dispersed using a rotor stator mixer. A moderately fine emulsion (fat particle ranging between 0.5 and 3 microns) with a microscopy picture given in FIGS. 1 B and C was then created by passing through a two-stage high pressure homogeniser (60 bar/20 bar first/second stage homogenisation pressures). The product was rendered microbiologically stable by thermal treatment with an ultra-high temperature treatment (UHT) of 143° C., 5 seconds.

### EXAMPLE 2

### Production of Faba Based Soft Serve Pre-Mix—With Secondary Emulsifier

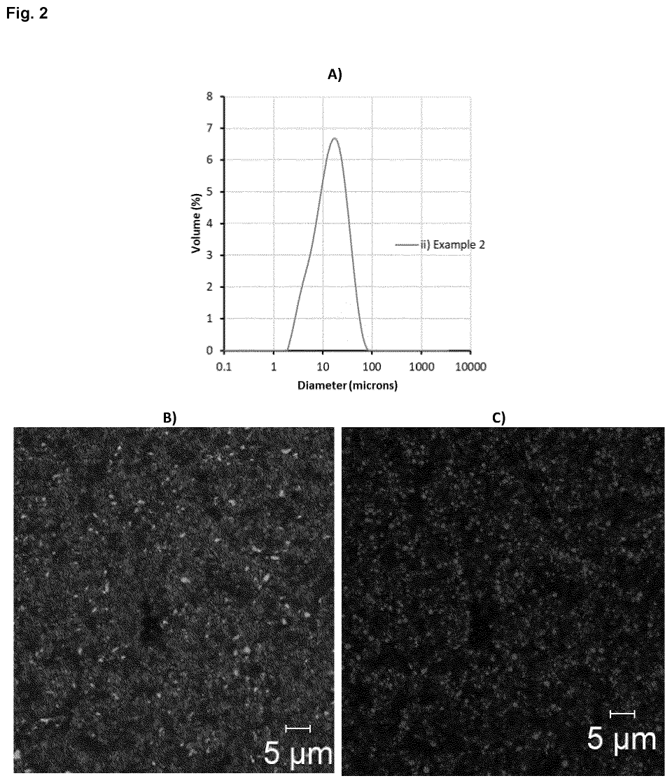

3.9 kg of Faba concentrate (Ingredion Pea Concentrate-Vitessence Pulse 3600) was dissolved in 35.8 kg of water at 65° C. with stirring, to this was added 7 kg of sucrose, 80 grams of dipotassium phosphate, and 35 grams of sodium ascorbate. This mixture was mixed at 65° C. for 15 minutes to ensure complete dissolution. The pH of the mixture was then adjusted to 7.5 with 1M NaOH. 2.5 kg of refined coconut fat (mp 22-24° C.) and 250 grams of glycerol monopalmitate were heated to <60° C. and blended together until a homogeneous liquid was achieved. The fat/monoglyceride blend was then added to the mix then final volume made to 50 litres and the oil was coarsely dispersed using a rotor stator mixer. A moderately fine emulsion with a microscopy picture given in FIGS. 2 B and C was then created by passing through a two-stage high pressure homogeniser (60 bar/20 bar first/second stage homogenisation pressures). The product was rendered microbiologically stable by thermal treatment with an ultra-high temperature treatment (UHT) of 143° C., 5 seconds.

### EXAMPLE 3

### Production of Faba Based Soft Serve Pre-Mix With Added Hydrocolloids

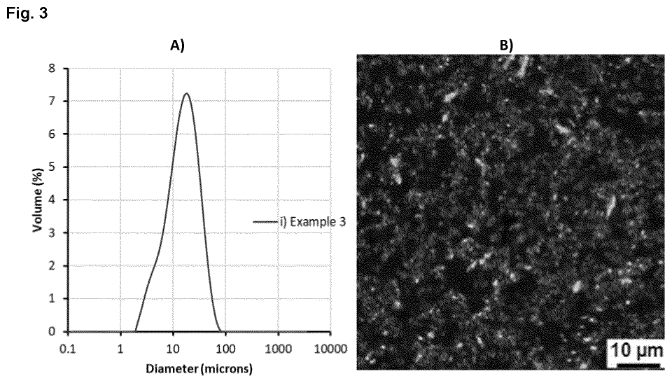

3.9 kg of Faba concentrate (Ingredion Pea Concentrate-Vitessence Pulse 3600) was dissolved in 34.8 kg of water at 65° C. with stirring, to this was added 8 kg of sucrose, 80 grams of dipotassium phosphate, 35 grams of sodium ascorbate and 200 grams of Cremodan SI 320 (a mixture of monoglyceride, methylcellulose and carrageenan). This mixture was mixed at 65° C. for 15 minutes to ensure complete dissolution. The pH of the mixture was then adjusted to 7.5 with 1M NaOH. 2.5 kg of refined coconut fat (mp 22-24° C.) and 75 grams of glycerol monopalmitate were heated to <60° C. and blended together until a homogeneous liquid was achieved. The fat/monoglyceride blend was then added to the mix then final volume made to 50 litres and the oil was coarsely dispersed using a rotor stator mixer. A moderately fine emulsion with a microscopy picture given in FIG. 3 B was then created by passing through a two-stage high pressure homogeniser (60 bar/20 bar first/second stage homogenisation pressures). The product was rendered microbiologically stable by thermal treatment with an ultra-high temperature treatment (UHT) of 143° C., 5 seconds.

### EXAMPLE 4

### Production of Faba Based Soft Serve Pre-Mix With Mixtures of Sugars

3.9 kg of Faba concentrate (Ingredion Pea Concentrate-Vitessence Pulse 3600) was dissolved in 34.8 kg of water at 65° C. with stirring, to this was added a mixture of sucrose and glucose syrup (DE 70) with a final percentage in recipe as outlined in Table 1, 80 grams of dipotassium phosphate, 35 grams of sodium ascorbate and 200 grams of Cremodan SI 320 (a mixture of monoglyceride, methylcellulose and carrageenan). This mixture was mixed at 65° C. for 15 minutes to ensure complete dissolution. The pH of the mixture was then adjusted to 7.5 with 1M NaOH. 2.5 kg of refined coconut fat (mp 22-24° C.) and 75 grams of glycerol monopalmitate were heated to <60° C. and blended together until a homogeneous liquid was achieved. The fat/monoglyceride blend was then added to the mix then final volume made to 50 litres and the oil was coarsely dispersed using a rotor stator mixer. A moderately fine emulsion was then created by passing through a two-stage high pressure homogeniser (60 bar/20 bar first/second stage homogenisation pressures). The product was rendered microbiologically stable by thermal treatment with an ultra-high temperature treatment (UHT) of 143° C., 5 seconds. The final plant based liquids had differing freezing points as outlined in Table 1.

Table 1 shows a change in plant based liquid freezing point as a function of sucrose/glucose syrup composition in plant based liquid mixture.

| Example | 3 | 4A | 4B | 4C |
|---|---|---|---|---|
| Faba concentrate (wt %) | 7.8 | 7.8 | 7.8 | 7.8 |
| Conconut Fat (wt %) | 5 | 5 | 5 | 5 |
| Sucrose (wt %) | 16 | 14 | 12 | 10 |
| glucose syrup DE 70 (wt %) | 0 | 2.9 | 5.7 | 8.5 |
| overrun (%) | 61 | 70 | 74 | 72 |
| freezing point (° C.) | −0.04 | −0.46 | −0.71 | −1.3 |

### EXAMPLE 5

### Production of Soft Serve Ice Cream From Faba Liquid Pre-Mixes

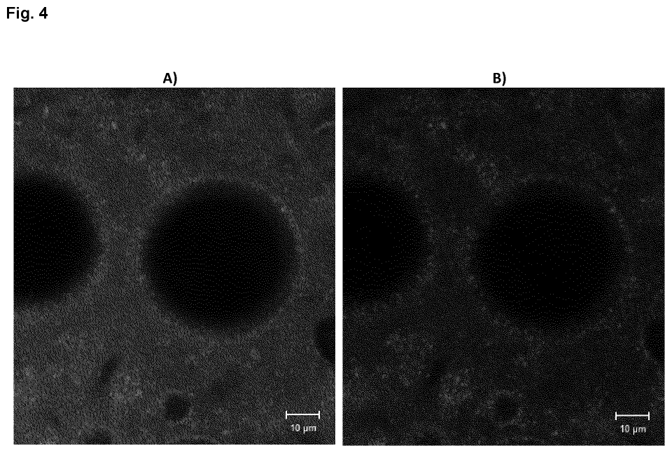

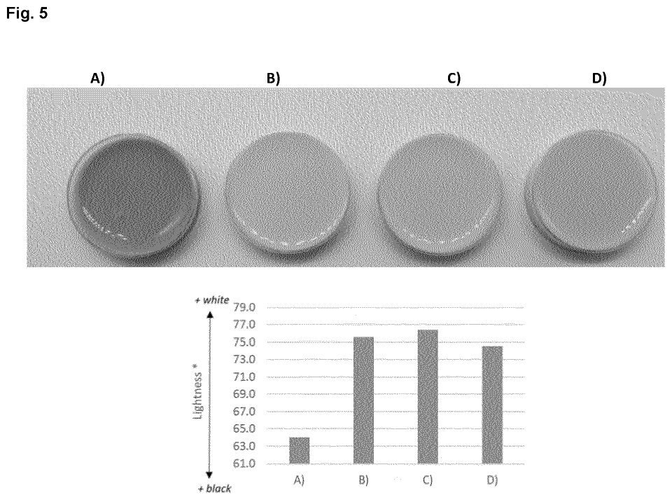

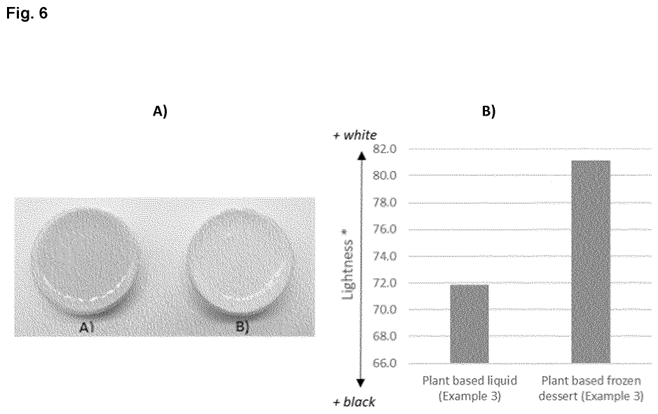

Soft serve ice cream (frozen dessert) were created by placing 10 kg of each of examples 1, 2, 3 by placing 10 kg of each liquid pre-mix into a Taylor model C716 soft serve ice cream machine. Each product was chilled to (and maintained at) a temperature of 4° C. in the machine hopper before being passed through the freezing cylinder and exiting the dosing head. Table 1 presents the change in ice cream overrun and freezing point as a function of recipe. FIG. 4 presents confocal micrographs of the ice cream microstructure resulting from example 2. Liquids that are used in soft serve ice cream machines are subjected to repeated heating cycles to ensure the microbiological safety of the recipe. A challenge with plant based liquids is that they turn grey after such cycles (FIG. 5A). Addition of sodium ascorbate prevents this FIG. 5B to D. Soft serve ice creams made from plant based liquids containing sodium ascorbate show high whiteness FIG. 6.

1. A method of making a plant based liquid or a frozen dessert, said method comprising
Dissolving 2.5 to 10 wt % dry fractionated plant protein in water to form a plant protein mixture having a pH of between 6 and 9;
Adding sugar or a polyol to the plant protein mixture;
Adding one or more emulsifiers to the plant protein mixture;
Dispersing a fat phase in the plant protein mixture, wherein said fat phase solidifies at a temperature less than 30° C., and wherein said fat phase comprises one or more fat sources;
Homogenizing the plant protein mixture to form an emulsion; and
Applying a thermal treatment to the emulsion to form a plant based liquid.

2. The method according to claim 1, wherein the dry fractionated plant protein is derived from a legume source.

3. The method according to claim 1, wherein the dry fractionated plant protein is made using air classification.

4. The method according to claim 1, wherein sodium ascorbate is dissolved in the plant protein mixture or the emulsion.

5. The method according to claim 1, wherein the sugar is sucrose or glucose syrup.

6. The method according to claim 1, wherein the polyol is sorbitol or glycerol.

7. The method according to claim 1, wherein the hydrocolloid is carrageenan.

8. The method according to claim 1, wherein the fat phase comprises coconut fat.

9. (canceled)

10. A plant based liquid or frozen dessert made by a method according to claim 1.

11. A plant based liquid or a frozen dessert, said plant based liquid or frozen dessert comprising (i) a dry fractionated plant protein, (ii) sugar or a polyol; (iii) optionally one or more hydrocolloid(s); (iv) one or more emulsifiers; (v) a fat phase, wherein said fat phase solidifies at a temperature less than 30° C., and wherein said fat phase comprises one or more fat sources.

12. The frozen dessert according to claim 11, wherein the frozen dessert is a soft serve ice cream.

13. The frozen dessert according to claim 11 comprising between 0.5 to 25 wt % fat, and wherein the fat is emulsified in a plant based liquid.

14. The frozen dessert according to claim 11, wherein said frozen dessert is devoid of animal products.

15. (canceled)
